(19) United States
(12) Patent Application Publication
(10) Pub. No.: US 2003/0012373 A1
(43) Pub. Date: Jan. 16, 2003

(54) Semiconductor manufacturing system and information management method

(75) Inventors: Masaya Ogura, Tokyo (JP); Hideki Ina, Kanagawa (JP); Nobuaki Ogushi, Tochigi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/192,689

(22) Filed: Jul. 11, 2002

(30) Foreign Application Priority Data
Jul. 13, 2001 (JP) 2001-214192

(51) Int. Cl. H04K 1/00; H04L 9/00

(52) U.S. Cl. 380/30

(57) ABSTRACT

This invention is to inhibit people other than a specific person from browsing information in a semiconductor manufacturing system. The user of a semiconductor manufacturing apparatus (e.g., an exposure system) encrypts, using a public key (5), confidential information (4) which should be kept secret to the vendor and stores the information in a memory (40). The user can decrypt the encrypted confidential information (4) using a private key (6). The user can also provide a private key (7) to the vendor, as needed.

### FIELD OF THE INVENTION

The present invention relates to a semiconductor manufacturing system for manufacturing semiconductor devices and an information management method in the system.

### BACKGROUND OF THE INVENTION

A semiconductor manufacturing apparatus or system is sold from a maker to a customer (user) and used to manufacture semiconductor devices in a user's factory. Semiconductor device manufacturing includes, e.g., a preprocess such as resist coating on a wafer, circuit pattern exposure, circuit pattern development, and thin film formation for wiring and a post-process in which a wafer is cut, wiring is done, and packaging is executed to complete a device. Especially, an exposure system (e.g., a stepper and scanner) used to expose a circuit pattern on a wafer in the preprocess is required to have performance capable of exposing a circuit pattern having a line width on the submicron order and also have an overlay accuracy between layers on the order of several ten nm. For this purpose, a maker (vendor) often performs maintenance or setting support of an exposure system in a user's factory. Particularly, for an exposure system, setting of manufacturing conditions called a recipe is complex. For this reason, exposure conditions set by a user or other conditions set by a vendor greatly influence the circuit pattern forming accuracy.

However, it is unacceptable for a user to allow a vendor to access internal information of an apparatus in a user's factory because of the problem of security. This is because actual wafer exposure conditions are user's confidential information for semiconductor device manufacturing, and competing for know-how of manufacturing greatly contributes to improvement of the performance or yield of semiconductor devices.

A vendor sells a manufacturing apparatus such as an exposure system to a user. Generally, only a vendor can operate the key section of a system related to control of a manufacturing apparatus. A vendor often serves as the superuser of a system in operating the key section of the system. It means that the vendor is authorized to browse all data or files on the manufacturing apparatus.

Hence, a demand has arisen for a system capable of causing a vendor to set a manufacturing apparatus while keeping secret confidential information in the manufacturing apparatus under user's management.

### SUMMARY OF THE INVENTION

The present invention has been made in consideration of the above situation, and has as its object to, e.g., inhibit people other than a specific person from browsing information in a semiconductor manufacturing system.

More specifically, it is an object of the present invention to prevent any leakage of confidential information to an unwanted person (e.g., a vendor for a user) in a semiconductor manufacturing system accessible by the user or vendor.

According to an aspect of the present invention, there is provided a semiconductor manufacturing system for manufacturing a semiconductor device, comprising a memory (data storage) which holds information, and an encryption system configured to encrypt, using a public key, the information to be stored in the memory and decrypt, using a private key, the encrypted information stored in the memory.

According to a preferred aspect of the present invention, preferably, the encryption system encrypts the information using the public key input by a user of the semiconductor manufacturing system and decrypts the information using the private key input by the user or a vendor of the semiconductor manufacturing system.

According to a preferred aspect of the present invention, the semiconductor manufacturing system is adapted to, e.g., an exposure system and comprises an exposure processing section which executes an exposure process on the basis of the information stored in the memory.

According to another aspect of the present invention, there is provided an information management method in a semiconductor manufacturing system, comprising encrypting information using a public key input by a user of the semiconductor manufacturing system, storing the encrypted information in a memory, decrypting the encrypted information stored in the memory using a private key input by the user or a vendor of the semiconductor manufacturing system, and providing the decrypted information to the person who has input the private key.

The semiconductor manufacturing system includes, e.g., an exposure system.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the schematic arrangement of an exposure system serving as a semiconductor manufacturing apparatus according to a preferred embodiment of the present invention;

FIG. 2 is a block diagram showing another example of handling of confidential information;

FIG. 3 is a view conceptually showing information management by multiple security levels;

FIG. 4 is a flow chart showing the detailed flow of a wafer process; and

FIG. 5 is a flow chart showing the flow of an overall manufacturing process of a semiconductor device.

### DETAILED DESCRIPTION OF THE PREFERRED EMBODIMENT

In this embodiment, when a person in charge of a vendor accesses a semiconductor manufacturing apparatus, which is delivered from the vendor to a user and used in a user's factory, for the purpose of maintenance/inspection and operation, the person in charge of the vendor is inhibited from accessing user's specific information (confidential information). Additionally, in this embodiment, an encryption key (public key) and a decryption key (private key) are used to guarantee that only a user's intended person can access the specific information.

More specifically, in this embodiment, the user of a semiconductor manufacturing apparatus encrypts information which should be kept secret to the vendor using a user's public key. Since the information encrypted using the user's public key can be decrypted only by a user's private key, the vendor cannot browse the information.

Furthermore, in this embodiment, when the user of the semiconductor manufacturing apparatus wants the vendor to browse specific information and also wants to manage vendor's browsing of the information, the user encrypts the information using a vendor's public key. Since the information encrypted using the vendor's public key can be decrypted only by a vendor's private key, the information is disclosed to only the vendor. When the information is browsed, the user can know that the vendor has browsed the information. According to this embodiment, information can easily be managed. When a plurality of security levels are set for public and private keys, for example, a security level can be set in accordance with the contents of each information.

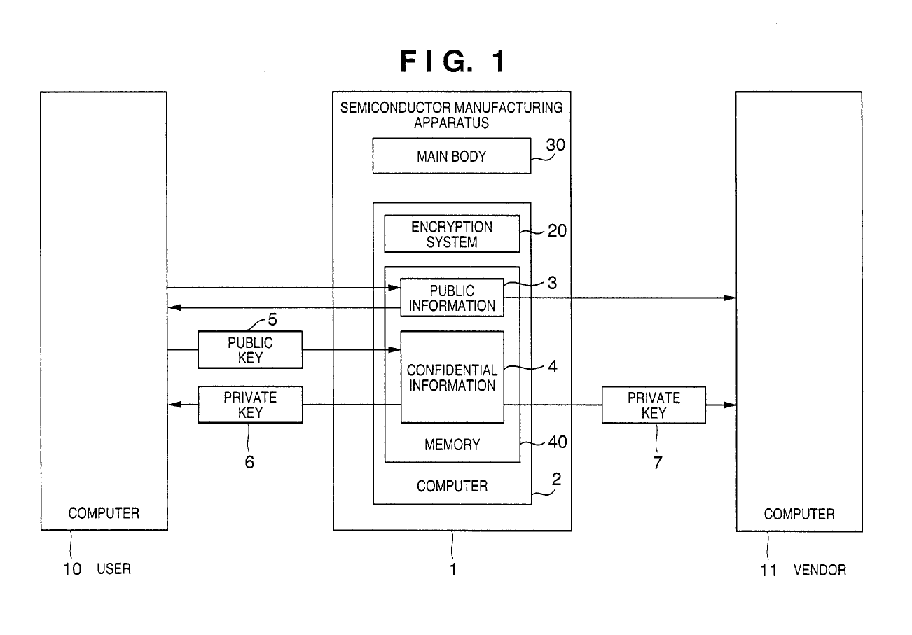

FIG. 1 is a block diagram showing the schematic arrangement of an exposure system serving as a semiconductor manufacturing apparatus according to a preferred embodiment of the present invention. A semiconductor exposure apparatus 1 exposes a circuit pattern on a reticle onto a resist applied to a wafer. The semiconductor exposure apparatus 1 changes the offset values and the optical system conditions (e.g., illumination conditions) of a lens, alignment conditions used to expose a circuit pattern to a desired position, and exposure time in accordance with a desired circuit pattern, thereby executing an exposure process under optimum exposure conditions. The semiconductor exposure apparatus 1 stores various conditions represented by the above conditions. Optimum exposure conditions are selected by the user and used in accordance with a circuit pattern used for exposure.

The semiconductor exposure apparatus 1 has a computer (e.g., a workstation) 2 for controlling its operation. Conditions set by the user are also stored in the computer 2. The user selects appropriate conditions from various exposure conditions stored in the computer 2 and operates the semiconductor exposure apparatus 1 in accordance with the selected conditions.

For example, information about optimum conditions for each circuit pattern used for exposure is stored in the computer 2 as confidential information 4. Information about inappropriate exposure conditions is stored in the computer 2 as public information 3. In storing (saving) the confidential information 4 in the computer 2, the user can set such a security level for the confidential information 4 that only a user having a specific account can browse the information.

The semiconductor exposure apparatus 1 is subjected to operations for maintenance by a serviceperson of the vendor to maintain the accuracy even after the apparatus is installed in the user's factory. The operations include, e.g., replacement of various kinds of components such as expendables and upgrading. At this time, the serviceperson of the vendor may need to change even the basic control software of the semiconductor exposure apparatus 1, which cannot be changed only by settings (user settings) open to the user. To do this, the serviceperson of the vendor is authorized as a superuser to change even the basic settings of the computer 2 for controlling the semiconductor exposure apparatus 1.

The superuser generally has authority to unconditionally browse all files (information) on the computer 2. For this reason, the serviceperson of the vendor can browse even information that the user wants to keep secret to him. Of course, they agree on the obligation of keeping secrecy in the maintenance contract. For works in the user's factory, the user can attend to on-site management of information. However, for example, when the serviceperson of the vendor executes works in a remote log-in state by remote operation through the Internet, more reliable security management is necessary.

In this embodiment, an encryption system 20 is employed to, when the user is going to store the confidential information 4 in a memory 40 of the semiconductor exposure apparatus 1, encrypt the confidential information 4 by a user's public key 5 and decrypt the encrypted confidential information 4 by a private key 6 corresponding to the public key 5. This encryption system 20 is generally called an RSA cryptographic system. In the RSA cryptographic system, information is encrypted at a security level of 1,024 bits or more. It is therefore very difficult to decrypt the information. The superuser can hardly decrypt the information by accessing it using the file operation authority or browsing authority.

When the user decrypts the encrypted confidential information 4 using his private key 6, as needed, the confidential information 4 can be returned to normal character codes or control document (plain text). After decryption, the user can arbitrarily select whether the encrypted confidential information (original information) 4 that is not necessary anymore should be deleted or held. The user may discard the decrypted confidential information 4. Alternatively, the user may encrypt the confidential information again by the encryption system 20 and save the information in the computer 2.

The semiconductor manufacturing apparatus 1 (computer 2) and a computer 11 of the vendor can be connected through, e.g., a data communication network such as the Internet. The semiconductor manufacturing apparatus 1 (computer 2) and the computer 11 of the vendor may be connected through, e.g., a local area network in the factory where the semiconductor manufacturing apparatus 1 is installed and the Internet.

The serviceperson of the vendor can log in to the computer 2 of the semiconductor exposure apparatus 1 in the user's factory from a remote site using the computer 11.

The user can permit the vendor to browse the encrypted confidential information 4 by disclosing to the vendor a private key 7 corresponding to the user's public key 5.

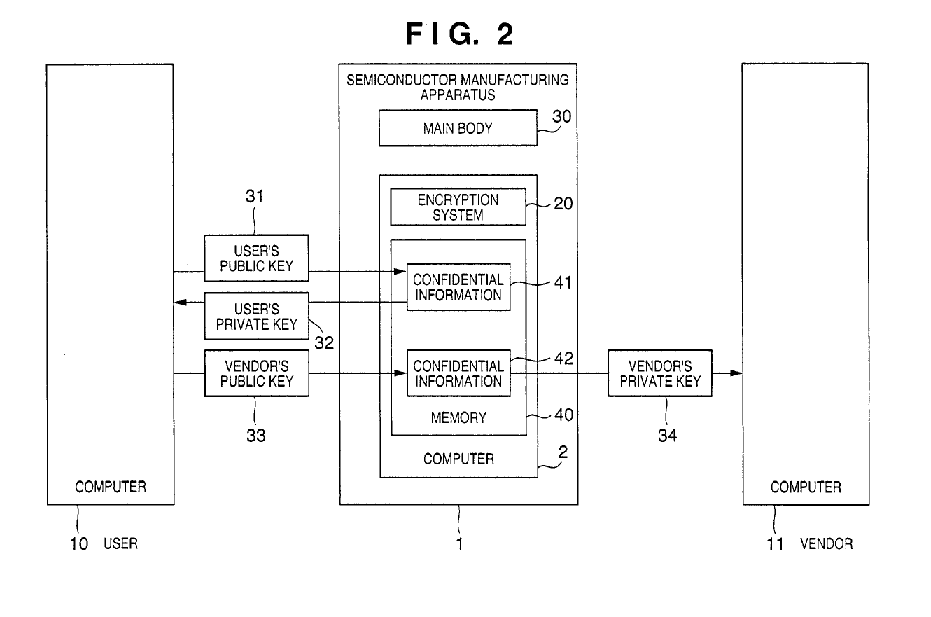

FIG. 2 is a block diagram showing another example of handling of confidential information. Of pieces of confidential information 41 and 42, the user can encrypt only the confidential information 42 using a vendor's public key 33 and the remaining information 41 using a user's public key (public key used only by the user) 31 and store the information in the memory 40. In this case, for the confidential information 42 that is encrypted using the vendor's public key 33, the vendor can decrypt the information using a vendor's private key 34 corresponding to the vendor's public key 33. However, for the confidential information 41 that is encrypted using the user's public key 31, the vendor cannot decrypt the information because he does not have a user's private key 32 corresponding to the user's public key 31.

Even on the user side, a person who does not have the vendor's private key 34 cannot access the confidential information 42. The confidential information 42 corresponds to, e.g., information that a specific person on the user side wants to disclose to the vendor while keeping the information secret to the remaining persons on the user side.

More generally, only a specific person on the user side and a specific person on the vendor side can be permitted to browse information. In this case, a private key corresponding to a public key used for encryption is provided to only persons who are permitted to browse the information.

The encryption system 20 can be arranged in, e.g., the computer 2 mounted in the semiconductor manufacturing apparatus 1, as shown in FIG. 1. In this case, the encryption system 20 can encrypt and store the confidential information 4 in the computer 2 on the basis of the public key 5 supplied from a computer 10 of the user and decrypt the encrypted confidential information 4 on the basis of the private key 6 supplied from the computer 10 of the user or the private key 7 supplied from the computer 11 of the vendor. When the semiconductor exposure apparatus 1 uses the encrypted confidential information 4, the encryption system 20 typically decrypts the confidential information 4 on the basis of the private key 6 supplied from the computer 10 of the user and provides the confidential information 4 to a main body (e.g., the exposure system main body or exposure processing section) 30.

The encryption system 20 may be arranged in the computer 10 of the user and the computer 11 of the vendor. This example will be described with reference to FIG. 1. When the user wants to store the confidential information 4 in the computer 2 of the semiconductor manufacturing apparatus 1, he encrypts the confidential information 4 using the public key 5 by the encryption system arranged in the computer 10. Then, the confidential information is transferred to and stored in the computer 2. When the user wants to browse the encrypted confidential information 4 stored in the computer 2 of the semiconductor manufacturing apparatus 1, he reads out the confidential information 4 from the computer 2 and decrypts the confidential information 4 using the private key 6 by the encryption system arranged in the computer 10. When the vendor wants to browse the encrypted confidential information 4 stored in the computer 2 of the semiconductor manufacturing apparatus 1, he decrypts the confidential information 4 using the private key 7 by the encryption system arranged in the computer 11.

Additionally, in a system that allows a plurality of persons to access the semiconductor exposure apparatus 1, like a remote control system which logs in to the semiconductor manufacturing apparatus from a remote site and manages and controls information on the semiconductor manufacturing apparatus 1 by remote operation, pieces of information are preferably managed in accordance with multiple security levels.

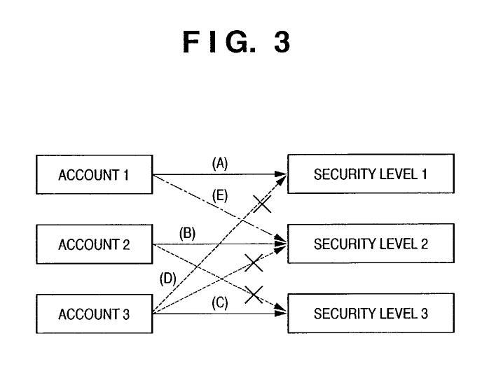

FIG. 3 is a view conceptually showing information management by multiple security levels. A user (either a user on the user side or a user on the vendor side) to which account 1 is given has access right to information of security level 1. A user (either a user on the user side or a user on the vendor side) to which account 2 is given has access right to information of security level 2. A user (either a user on the user side or a user on the vendor side) to which account 3 is given has access right to information of security level 3.

A common private key corresponding to the security level (access right) is provided to the user of each account. Hence, each user can decrypt information encrypted by a corresponding public key. More specifically, for example, information encrypted by a public key of security level 1 can be decrypted only by a common private key provided to the user of account 1 (A) For example, information encrypted by a public key of security level 2 can be decrypted only by a common private key provided to the user of account 2 (B). For example, the user of account 3 cannot browse information encrypted by the common public key of security level 1 or 2 (C or D).

As indicated by (E) in FIG. 3, the user of account 1 may be permitted to decrypt information encrypted by a public key corresponding to security level 2. Hence, browsing can be permitted or inhibited in accordance with the security level (E).

When the users of accounts 1, 2, and 3 are commonly notified of the information storage locations, the security level of a public key to be used for encryption is arbitrarily selected, and the log of decryption operation is monitored, users and their accessing processes to each information can be grasped (managed).

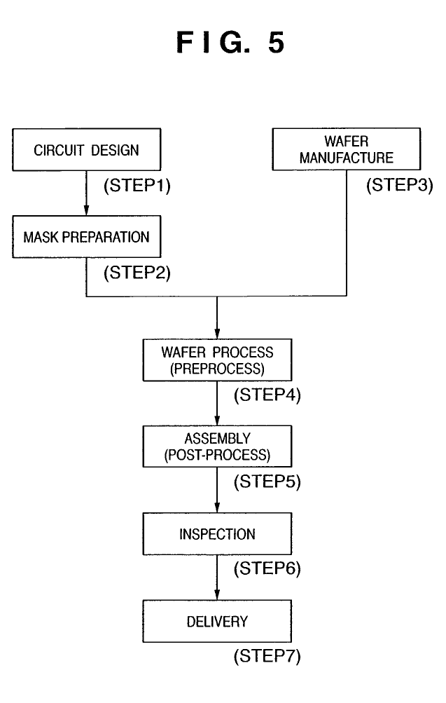

A semiconductor device manufacturing process using the above exposure system will be described next. FIG. 5 shows the flow of an overall manufacturing process of a semiconductor device. In step 1 (circuit design), the circuit of a semiconductor device is designed. In step 2 (mask preparation), a mask is prepared on the basis of the designed circuit pattern. In step 3 (wafer manufacture), a wafer is manufactured using a material such as silicon. In step 4 (wafer process) called a preprocess, an actual circuit is formed on the wafer by lithography using the mask and wafer. In step 5 (assembly) called a post-process, a semiconductor chip is formed from the wafer prepared in step 4. This step includes processes such as assembly (dicing and bonding) and packaging (chip encapsulation). In step 6 (inspection), inspections including operation check test and durability test of the semiconductor device manufactured in step 5 are performed. A semiconductor device is completed with these processes and delivered (step 7).

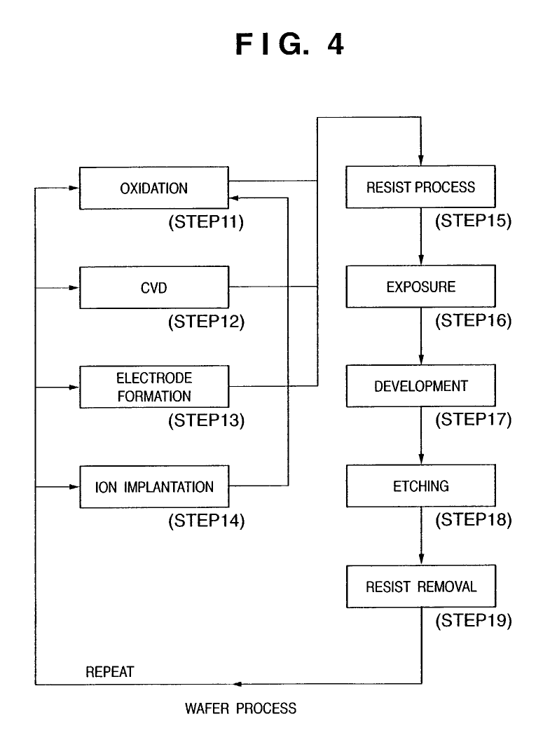

FIG. 4 shows the detailed flow of the wafer process. In step 11 (oxidation), the surface of the wafer is oxidized. In step 12 (CVD), an insulating film is formed on the wafer surface. In step 13 (electrode formation), an electrode is formed on the wafer by deposition. In step 14 (ion implantation), ions are implanted into the wafer. In step 15 (resist process), a photosensitive material is coated to the wafer. In step 16 (exposure), the circuit pattern is transferred onto the wafer by the exposure system. In step 17 (development), the exposed wafer is developed. In step 18 (etching), portions other than the developed resist image are etched. In step 19 (resist removal), any unnecessary resist remaining after etching is removed. By repeating these steps, a multilayered structure of circuit patterns is formed on the wafer.

According to the present invention, for example, people other than a specific person can be inhibited from browsing information in a semiconductor manufacturing system.

As many apparently widely different embodiments of the present invention can be made without departing from the spirit and scope thereof, it is to be understood that the invention is not limited to the specific embodiments thereof except as defined in the claims.

What is claimed is:

1. A semiconductor manufacturing system for manufacturing a semiconductor device, comprising:
a memory which holds information; and
an encryption system configured to encrypt, using a public key, the information to be stored in said memory and decrypt, using a private key, the encrypted information stored in said memory.

2. The system according to claim 1, wherein said encryption system encrypts the information using the public key input by a user of the semiconductor manufacturing system and decrypts the information using the private key input by the user or a vendor of the semiconductor manufacturing system.

3. The system according to claim 1, wherein the semiconductor manufacturing system is adapted to an exposure system and comprises an exposure processing section which executes an exposure process on the basis of the information stored in said memory.

4. An information management method in a semiconductor manufacturing system, comprising:
encrypting information using a public key input by a user of the semiconductor manufacturing system;
storing the encrypted information in a memory;
decrypting the encrypted information stored in the memory using a private key input by the user or a vendor of the semiconductor manufacturing system; and
providing the decrypted information to the person who has input the private key.

5. The method according to claim 4, wherein the semiconductor manufacturing system includes an exposure system.
